(19) United States
(12) Patent Application Publication
(10) Pub. No.: US 2012/0177870 A1
(43) Pub. Date: Jul. 12, 2012

(54) BALLISTIC MATERIALS

(76) Inventor: Phra Douglas Lyle, Aiken, SC (US)

(21) Appl. No.: 12/042,430

(22) Filed: Mar. 5, 2008

Related U.S. Application Data
(60) Provisional application No. 60/893,021, filed on Mar. 5, 2007.

(51) Int. Cl. F41H 5/04; B32B 17/04; B32B 37/14; B32B 5/12

(52) U.S. Cl. 428/113; 442/60; 442/189; 442/348; 428/221; 156/60

(57) ABSTRACT

A ballistic impact resistant composite comprising a glass fiber and a resin, where the glass fiber consists essentially of fiber having a diameter of less than 9 microns, is provided. The ballistic impact resistant article or composite comprising fiber less than 9 micron yields a higher V50 value at the same areal density, or the same V50 value at a lower areal density, than an impact resistant article or composite comprising fiber of greater than 9 micron.

### CROSS-REFERENCE TO RELATED APPLICATION

The present application claims priority to U.S. Provisional Patent Application No. 60/893,021 filed on Mar. 5, 2007, the contents of this application is hereby incorporated by reference herein.

### FIELD OF INVENTION

This invention relates generally to ballistic impact resistant articles and composites, and more particularly to lighter weight and lower areal density ballistic impact resistant articles formed from finer diameter glass fibers.

### BACKGROUND

There is an ongoing and escalating need for ballistic impact resistant articles that are able to withstand an increased threat to personnel and equipment from direct small arms fire and the shrapnel and fragments created by exploding mines, grenades, and other blast induced threats. Typical applications for ballistic impact resistant articles and composites include armor for naval ships, military vehicles, automobiles, tactical shelters, transportable containers, as well as, riot shields, helmets, and other personnel protective devices.

In the last ten years, ballistic impact resistant composites reinforced with high strength glass fibers, “S-glass”, have been qualified and specified on nearly every major U.S. military armored vehicle system. Hard armor composites made with S-glass fiber are advantageous as they function as both a ballistic and a structural material. The outstanding ballistic protection and structural performance provided by hard composite armor applications made with S-glass fibers is a result of the high tensile and compressive strengths of S-glass fibers. In addition, S-glass fibers have a high elongation to break property, which plays an important role in the dynamic ballistic impact-absorbing mechanism of the composites made with these fibers. Other advantages provided by S-glass fiber in addition to structural and ballistic impact resistance performance, are protection against fire and smoke, and reduced costs without sacrificing ballistic performance. These are key factors considered in the defense market.

As the threat to personnel and equipment has increased, however, there is a need for ballistic impact resistant articles that can match the threat without becoming unduly heavy or bulky. For this reason, there is a need for ballistic impact resistant articles and composites that offer ballistic threat protection at reduced weight.

### SUMMARY

A ballistic impact resistant article is provided that improves ballistic impact threat performance without additional weight or thickness to the article. In one aspect, a ballistic impact resistant article is provided, comprising glass fibers of less than 9 micron filament diameter and a resin. The glass fiber of the ballistic impact resistant article consists essentially of by weight:

| | |
|---|---|
| SiO₂ | 56-66% |
| Al₂O₃ | 10-26% |
| MgO | 5-15% |
| CaO | 0-10% |
| B₂O₃ | 0-1% |
| alkali metal oxides | 0-1% |
| Fe₂O₃ | 0-0.5% |
| F₂ | 0-0.5%. |

In one aspect, the glass fibers of the ballistic impact resistant article have a pristine fiber tensile strength of greater than 500 kpsi.

In one aspect, the ballistic impact resistant article includes one or more layers, at least one of the layers comprising a woven or network of the glass fiber. The woven or network of glass fiber may be impregnated with a resin and may also have a water resistant, impact debondable size coating thereon.

In one aspect, a ballistic impact resistant article is provided, comprising a glass fiber having a diameter of about 7.5 microns or less and having a pristine fiber tensile strength of 665 kpsi or greater and a tensile modulus of 12.5 Mpsi or greater.

In another aspect, a ballistic impact resistant laminate structure is provided, comprising stacked layers of fiber networks. The fiber networks comprise a glass fiber having a diameter of less than 9 microns and a pristine fiber tensile strength of 500 kpsi or greater. The layers of fiber networks are impregnated with a heat curable resin, and the resin impregnated stacked layers are consolidated to produce the laminate structure.

In another aspect, a process is provided for producing ballistic impact resistant materials. The process comprises providing at least one layer of a woven or network, the network comprising a glass fiber of less than 9 micron filament diameter, impregnating the layer of woven or fiber network with a resin, stacking the layer of woven or fiber network impregnated with resin, and consolidating the stack of woven or fiber network impregnated with resin. The glass fiber of the ballistic impact resistant material has a pristine fiber tensile strength of greater than 500 kpsi.

In another aspect, a method of reducing a fragment projectile penetration threat is provided. The method comprises providing a ballistic impact resistant article comprising glass fibers having a diameter of less than 9 microns and a resin. The ballistic impact resistant article has at least one of the following characteristics:
an areal density of about 6.2 pounds per square foot at a thickness of about 0.58 inches and has an average V50 value, protection ballistic limit in excess of about 4400 feet per second with 5.56 mm fragment simulating projectiles (FSP's);
an areal density of about 5.2 pounds per square foot at a thickness of about 0.48 inches and has an average V50 value, protection ballistic limit in excess of 2700 feet per second with 7.62 mm fragment simulating projectiles;
an areal density of about 12.4 pounds per square foot at a thickness of about 1.2 inches and has an average V50 value, protection ballistic limit in excess of 3450 feet per second with 12.7 mm fragment simulating projectiles; and
an areal density of about 20.8 pounds per square foot at a thickness of about 2 inches and has an average V50 value, protection ballistic limit in excess of 3800 feet per second with 20 mm fragment simulating projectiles.

### BRIEF DESCRIPTION OF THE DRAWINGS

FIG. 1 graphically depicts the V50 performance curve for a 7.62 mm M80 ball round threat against unfaced ballistic resistant composite panel having 7 micron glass fibers embedded in a resin versus a composite panel control having 9 micron glass fibers.

FIG. 2 graphically depicts the areal density required to achieve a V50 of 2500 fps as a function of fiber diameter for a 7.62 mm M80 ball round threat against an unfaced composite panel.

FIG. 3 graphically depicts the V50 performance curve for a 5.56 mm FSP threat against unfaced ballistic resistant composite panel comprising about 7 micron glass fibers versus a composite panel control having 9 micron glass fibers.

FIG. 4 graphically depicts the V50 performance curve for a 7.62 mm FSP threat against unfaced ballistic resistant composite panel comprising about 7 micron glass fibers versus a composite panel control having 9 micron glass fibers.

FIG. 5 graphically depicts the V50 performance curve for a 12.7 mm FSP threat against unfaced ballistic resistant composite panel comprising about 7 micron glass fibers versus a composite panel control having 9 micron glass fibers.

FIG. 6 graphically depicts the V50 performance curve for a 20 mm FSP threat against unfaced ballistic resistant composite panel comprising about 7 micron glass fibers versus a composite panel control having 9 micron glass fibers.

FIG. 7 graphically depicts measured and calculated normalized areal density/FSP threat versus V50 curve for unfaced ballistic resistant composite panels, each of decreasing finer diameter glass fibers versus a composite panel control having 9 micron glass fibers.

### DETAILED DESCRIPTION

Described herein is an impact resistant material comprising finer filament diameter glass fibers for articles and composites and their construction. In one aspect, a finer diameter glass fiber is used in constructing lighter weight and lower areal density ballistic impact resistant articles and composites. The ballistic articles and composites described herein meet or surpass military ballistic acceptance tests at a lower weight or lower areal density as compared to similarly designed articles having larger diameter glass fibers.

Unless otherwise stated, the following terms used in the specification and claims have the meanings given below.

By “fiber” is meant an elongate body, the length dimension of which is much greater than the transverse dimensions of width and thickness. Accordingly, the term fiber includes monofilament, multifilament, ribbon, strip, staple and other forms of chopped, cut or discontinuous fiber and the like having regular or irregular cross-sections. Fiber and filament are used interchangeably herein. Accordingly, the phrases “finer diameter glass fiber” and “finer filament diameter glass fiber” are also used interchangeably herein.

By “network” is meant fibers arranged in figurations of various types. For example the plurality of fibers can be grouped together to form a twisted or untwisted yarn. The fibers of yarn may be formed as a felt, knitted or woven (plain, basket, stain and crow feet weaves, etc.) into a network, fabricated into a non-woven fabric (random or ordered orientation), arranged in a parallel array, layered, or formed into a fabric by any of a variety of conventional techniques.

The terms “S-glass” and “E-glass” are used according to their meaning as described in ASTM D-578. For example, S-glass fibers are generally comprised of the oxides of magnesium, aluminum, and silicon. S-glass fibers may further include trace amounts of alkali metal oxides and iron oxides. E-glass fibers are generally comprised of the oxides of calcium, aluminum, and silicon.

The term “R-glass” is used to describe glass compositions generally comprised of the oxides of calcium, magnesium, aluminum, silicon, and trace amounts of boron oxides, iron oxides, and fluorine.

By “high strength” is meant a glass fiber having higher tensile strength and higher tensile modulus than E-glass fiber. Generally, high strength, finer diameter glass fibers disclosed herein may be S-glass fibers. Accordingly, the phrases “high strength glass fiber” and “high strength S-glass fiber” and “S-glass fiber” all have the same meaning when used herein. By way of example, high strength, finer diameter S-glass fibers have a pristine fiber tensile strength of greater than 500 kpsi, more preferably a pristine fiber tensile strength of greater than 600 kpsi, and most preferably a pristine fiber tensile strength of greater than 665 kpsi.

High strength, finer diameter glass fiber further includes compositions having a composition that deviates from the S-glass composition described above. Accordingly, use of the phrase “high strength glass fiber” is meant to encompass high strength glass fibers having compositions that deviate from S-glass compositions described above, with the proviso that the composition is other than that of E-glass.

When referring to high strength S-glass fibers described herein, the term “finer diameter” means glass fibers having a diameter of less than 9 microns. Any numerical value recited for a fiber diameter, however, inherently contains certain errors necessarily resulting from the standard deviation found in measuring the fiber diameter. Therefore, diameter values recited with the qualifier “about” are intended to encompass the nominal range for fiber diameter average as described in ASTM D-578. For example, glass fibers having diameter of “about 7 microns” includes fibers of diameter between 6.35 and 7.61 micron. As used herein, letter designations for glass fiber diameters are those in accordance with ASTM D-578. Accordingly, “7 micron diameter” and “E” are used herein interchangeably when referring to fibers. The finer diameter fibers described herein can be of any diameter at or less than 9 microns to about 8 microns (G to F filaments), glass fibers at about 7 microns in diameter (E filaments), glass fibers about 6 microns in diameter (DE), glass fibers about 5 microns in diameter (D), or glass fibers about 3.5 microns in diameter (C). Accordingly, the phrase “finer filament diameter glass fiber” refers to a glass fiber having a diameter from less than 9 to about 3.5 microns. Finer filament diameter glass fibers of the diameters from less than 9 to about 3.5 microns may be roving strands, which are untwisted, unplied gatherings of filaments drawn in parallel orientation. Finer filament diameter glass fibers from less than 9 to about 3.5 microns disclosed herein particularly include high strength glass fibers of tensile strength greater than about 500 kpsi, such as, S-glass and R-glass.

By “roving” is meant a collection of continuous glass strands gathered substantially without mechanical twisting. The strands of the roving are preferably treated with a sizing agent for compatibility with a resin matrix.

By “V50” is meant the velocity at which 50% of projectiles completely penetrate a test panel, and 50% of the projectiles partially penetrate the test panel. To create a V50 data point, a given threat is fired at a test panel. If this projectile results in a complete penetration of the panel, then the velocity of the next projectile is reduced until the projectile does not pass through the panel or results in a partial penetration. V50 values are used to benchmark ballistic performance and to compare test panels comprising glass fiber as disclosed herein with a control.

As used herein, “comprising,” “including,” “containing,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.” As used herein, “consisting of” and grammatical equivalents thereof exclude any element, step, or ingredient not specified in the claim.

As used herein, “consisting essentially of” and grammatical equivalents thereof limit the scope of a claim to the specified materials or steps and those that do not materially affect the basic and novel characteristic or characteristics of the claimed invention. For example, the ballistic impact resistant articles described herein may include an amount of fibers of a size greater than G-fiber diameter provided that the V50 value of a composite article is not substantially altered from that of a composite article having only fibers of less than 9 microns. Additionally, for example, the ballistic impact resistant articles described herein may include glass fibers of a composition other than S-glass or R-glass provided that the V50 value of a composite article is not substantially altered from that of a composite article having only fibers having only S-glass or R-glass composition.

In one aspect, the invention is directed to glass fibers having a diameter of less than 9 microns having a higher tensile strength and a higher tensile modulus than, for example, E-glass fibers of similar diameter for use in constructing lighter weight and lower areal density ballistic impact resistant articles and composites. In another aspect, the invention is directed to lower diameter S-glass fibers, such as E, F,G, D, DE or C diameter S-glass fibers, for use in constructing lighter weight and lower areal density ballistic impact resistant articles and composites.

In one embodiment, the glass fiber of the ballistic impact resistant article consists essentially of by weight:

| | |
|---|---|
| SiO₂ | 56-66% |
| Al₂O₃ | 10-26% |
| MgO | 5-15% |
| CaO | 0-10% |
| B₂O₃ | 0-1% |
| alkali metal oxides | 0-1% |
| Fe₂O₃ | 0-0.5% |
| F₂ | 0-0.5%. |

In one aspect, the ballistic impact resistant article comprises glass fiber having a diameter of less than 9 microns and a pristine fiber tensile strength at room temperature of greater than 500 kpsi. Accordingly, high strength, finer diameter S-glass fibers may be comprised of a composition of about 64-66% by weight silica, about 24-26% by weight alumina, and about 9-11% by weight magnesia. In another aspect, the glass fiber having a diameter of less than 9 microns has a composition comprising about 64-66% by weight silica, about 24-26% by weight alumina, and about 9-11% by weight magnesia; and has at least one of the following characteristics:
(i) a softening point of greater than 1900° F. as determined in accordance with ASTM C-338;
(ii) a tensile modulus at room temperature of greater than 12.5 Mpsi as determined in accordance with ASTM D2101;
(iii) a strain to failure of greater than 5.4% as determined in accordance with ASTM D2101; and
(iv) a dimensional stability of less than 2.0×10⁻⁶ in/in-degrees ° F.

In yet another aspect, the glass fiber having a diameter of less than 9 microns preferably has at least two of the characteristics (i)-(iv), more preferably at least three of the characteristics (i)-(iv). The glass fiber having a diameter of less than 9 microns may have a pristine fiber tensile strength at room temperature of greater than 500 kpsi, greater than 600 kpsi or greater than 665 kpsi, independently in combination with at least one of the characteristics (i)-(iv), at least two of the characteristics (i)-(iv) or at least three of the characteristics (i)-(iv).

In one aspect, a process is provided for constructing ballistic impact resistant articles and composites from finer diameter glass fibers. In one aspect, a ballistic impact resistant composite is formed from one or more layers of a woven or non-woven network of the finer glass fibers. The woven or non-woven glass fiber network can be a plain weave, a twill weave, a harness weave, a basket weave, a satin weave, a crossply, a biaxial, a triaxial, a quasi axial construction, or another form of woven roving or otherwise assembled fabric or mat. In one aspect, the form of glass fiber is a balanced woven roving configuration. The process further comprises impregnating layers of woven or fiber networks comprising the finer diameter glass fibers with a resin. A ballistic impact resistant composite is produced by stacking the layers and consolidating them. Consolidation includes treatment of the stacked layers to integrate the stack into the ballistic panel or article desired. Consolidation may be carried out under compression and/or using heat, light or other techniques commonly known in the art of composite manufacture.

Resins that are useful in construction of the ballistic impact resistant composites comprising fibers of less than 9 microns disclosed herein include thermosetting resins, thermoplastic resins, and elastomeric resins. Thermosetting resins are preferred and, in particular, phenolic resins are preferred. In addition, it is preferred that the smaller diameter glass fibers disclosed herein have a water resistant, impact debondable size coating thereon. Preferred size coatings are sizings containing an epoxy based film former and a silane coupling agent along with other conventional materials. Silane coupling agents include epoxy silane coupling agents.

In one aspect, the ballistic impact resistant composites comprising fibers of less than 9 microns disclosed herein include a hard strike face. Hard strike face includes ceramic, metal or materials capable of attenuating armor piercing projectile threats. Preferably, the hard strike face is ceramic. The hard strike face may be integrally formed with the ballistic impact resistant article. In other aspects, the hard strike face may be adjacent, adjoining or contiguous with the ballistic impact resistant article.

In a particular aspect, the process for producing a ballistic impact resistant material, such as a flat plate, is provided. The process comprises impregnating a woven finer diameter glass fiber roving, at glass fractions of about 65% by volume or greater, with a suitable polyester resin and a polymerizable monomeric solvent, in a volume percent of about 35% or below. The woven roving is cured in a molding unit at a temperature of about 225° F.-255° F. for a sufficient period of time and at a sufficient pressure to allow the impregnated woven roving to substantially conform to the mold unit. The temperature and pressure used are sufficient to maintain the exothermic temperature at about 300° F. or below, and to catalytically crosslink the resin. The foregoing example includes the use of any finer filament high strength glass rovings having a diameter smaller than, for example, that of a G filament.

Typically, the energy of a projectile is first absorbed by compressive failure of the impacted composite or laminate. Fibers are cut and a cavity is formed by the entering projectile. As the projectile continues penetrating the composite, it strikes individual strands that stretch, break and/or delaminate, further reducing the projectile's energy in a radial direction. The ballistic resistant composition of finer diameter fiber and resin disclosed herein is believed to provide a semi-compatible bond between the fiber and the resin when incorporated into a cured composite or laminate. Modification of the semi-compatible bond between the fiber and the resin may be achieved by selection of a suitable sizing agent. For example, for a thermoset resin, an epoxy based film former and an epoxy silane coupling agent may be used. While it is only one potential mechanism of action, the present inventors believe that the increase in ballistic performance that is observed for the ballistic resistant compositions of the cured composite or laminate herein disclosed comprising the finer diameter glass fibers is at least in part a result of an increase in fiber surface area, as well as increasing projectile-fiber-matrix interactions that result in stretching, breaking and/or delaminating. In addition, the present inventors believe that the finer diameter glass fibers are generally reduced in the amount of flaws and as a result, have on average, a higher tensile strength. These properties of the herein disclosed ballistic resistant composition comprising the finer diameter glass fibers independently or collectively reduce the projectile's kinetic energy with composites having less areal density.

A method of reducing a fragment projectile penetration threat using the ballistic resistant articles described herein is provided. The method comprises providing a ballistic impact resistant article comprising glass fibers having a diameter less than 9 microns and a resin. The ballistic impact resistant article has at least one of the following characteristics:
an areal density of about 6.2 pounds per square foot at a thickness of about 0.58 inches and an average V50 value, protection ballistic limit in excess of about 4400 feet per second with 5.56 mm fragment simulating projectiles;
an areal density of about 5.2 pounds per square foot at a thickness of about 0.48 inches and an average V50 value, protection ballistic limit in excess of 2700 feet per second with 7.62 mm fragment simulating projectiles;
an areal density of about 12.4 pounds per square foot at a thickness of about 1.2 inches and an average V50 value, protection ballistic limit in excess of 3450 feet per second with 12.7 mm fragment simulating projectiles; or
an areal density of about 20.8 pounds per square foot at a thickness of about 2 inches and an average V50 value, protection ballistic limit in excess of 3800 feet per second with 20 mm fragment simulating projectiles.

The present invention is further described by the following non-limiting examples. The following examples are illustrative of aspects of the present invention and are not to be interpreted as limiting or restrictive. Notwithstanding that the numerical ranges and parameters setting forth the broad scope of the invention are approximations, the numerical values set forth in the specific example is reported as precisely as possible. Any numerical value, however, inherently contain certain errors necessarily resulting from the standard deviation found in their respective measurements (e.g., weights, diameters, forces, percentages, etc.). Therefore, the modifier “about” is intended to include any errors necessarily resulting from the standard deviation found in a respective measurement.

The ballistic resistant composite panel as herein disclosed may be constructed of multiple layer laminates where at least one individual laminate consists of high strength glass fibers of less than 9 micron in fiber diameter. This process for preparing a ballistic impact resistant material flat plate comprising G-fiber (9 micron) and E-fiber (7 micron) S-glass, the composition of the S-glass being essentially as described in U.S. Pat. No. 5,006,293, the relevant portions of which are herein incorporated by reference. The amount of impregnating composition employed is selected so that the finally cured composite or laminate contains about 70% to about 90%, by weight, of the glass roving fabric or mat. In general, a sufficient number of plies of prepregs are compression molded such that a final composite thickness of about 1/16 to about 9 inches is obtained. Other composite thickness may be used.

The construction of ballistic impact resistant composites is well known in the art and is described, for example, in U.S. Pat. No. 3,861,982; No. 5,006,293; and No. 5,215,813, the relevant portions of each are herein incorporated by reference. However, it is understood that other composite manufacturing processes may be used, such as VARTM and prepreg as examples.

Thus, a standard glass formulation consisting by weight of 65% silica, 25% alumina, and 10% magnesium oxide was melted and then formed into fibers using conventional forming means. Slivers coated with a water resistant, impact debondable sizing were produced:
7 micron diameter filaments, 600 filaments/end, 15-end assembled roving;
Control—G-fiber (9 micron) filaments, 400 filaments/end, 30-end assembled roving;
13 micron filaments, 200 filaments/end, 15-end assembled roving

These slivers were each then assembled into 250 yard/pound rovings. A 24 micron 250-yield single end roving containing 1854 filaments was also produced. The rovings were then woven by BGF Industries, Greensboro, N.C. into plain weave, five threads/inch, 24 ounce/square-yard fabrics. The fabrics were impregnated with SC1008 phenolic resin (Hexion Specialty Chemicals, Inc., Columbus, Ohio) to produce prepreg materials with a resin content of about 22% by weight. The prepregs were supplied in a partially cured (B-staged) condition and were stored at less than 55° F. to prevent further curing. Laminates of three different areal densities: 30, 40, and 50 kilograms/square meter, were produced by pressing several plies of the prepreg materials in a press at 340° F. for 30 minutes. The target fiber weight fraction of the laminates was 80%+/−1%. Three samples were prepared and tested and are summarized in Table 1.

TABLE 1

| Sample | Description |
|---|---|
| 7 micron | SC1008 resin using a 24 oz plain weave fabric |
| | constructed of a 250 yield 463 S-2 Glass roving. |
| | The input roving was a 30 end product of 7 micron |
| | fiber. |
| 13 micron | SC1008 resin using a 24 oz plain weave fabric |
| | constructed of a 250 yield 463 S-2 Glass roving. |
| | The input roving was a 15 end product of 13 micron |
| | fiber. |
| Control | SC1008 resin using a 24 oz plain weave fabric |
| (9 micron) | constructed of a 250 yield 463 S-2 Glass roving. |
| | The input roving was a 30 end product of 9 micron |
| | fiber. |
| 24 micron | SC1008 resin using a 24 oz plain weave fabric |
| | constructed of a 250 yield S-2 Glass roving. The |
| | input roving was a 1 end product made with a 24 |
| | micron fiber. |

V50 ballistic performance for ballistic threat was measured for these samples prepared as composite panels in accordance with MIL-STD-662F “V50 Ballistic Test for Armor.” A V50 data point was generated from approximately 4-7 shots on target at a range of 25 ft to establish an average V50 velocity.

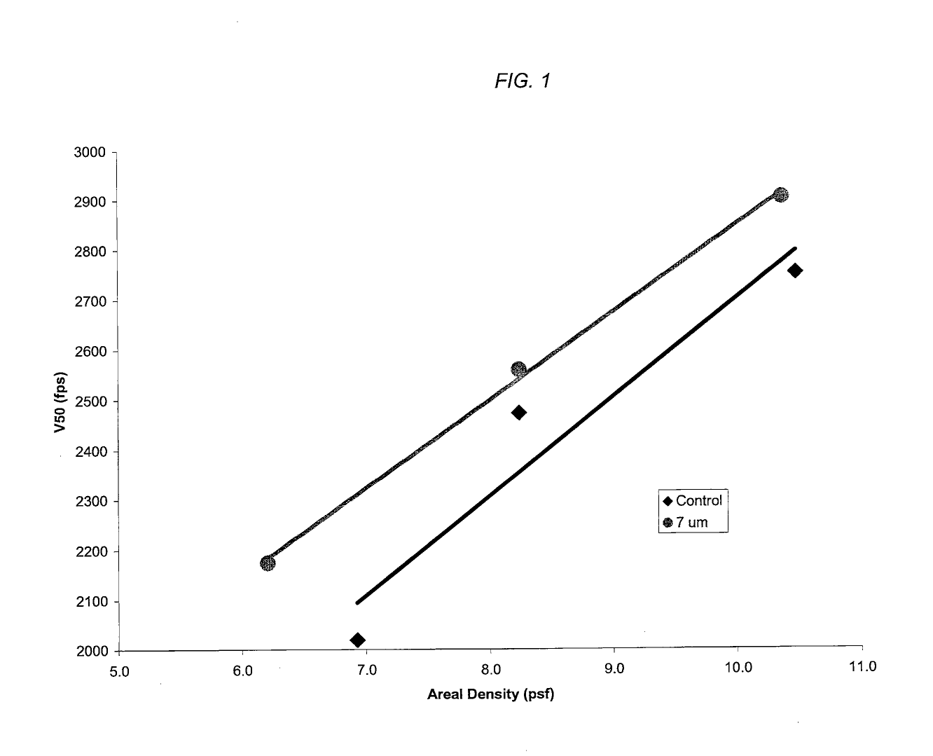

FIG. 1 depicts graphically the V50 performance curve for a 7.62 mm M80 ball round threat against an unfaced ballistic resistant composite panels described in Table 1 against the unfaced control. It can be seen from the FIG. 1 that V50 performance is approximately a linear relationship with areal density within the boundaries tested. The finer fiber E filament 463 roving input comprising 7 micron diameter filaments demonstrated a ballistic performance premium at all three areal densities tested compared to the control, 13 micron and 24 micron containing panels.

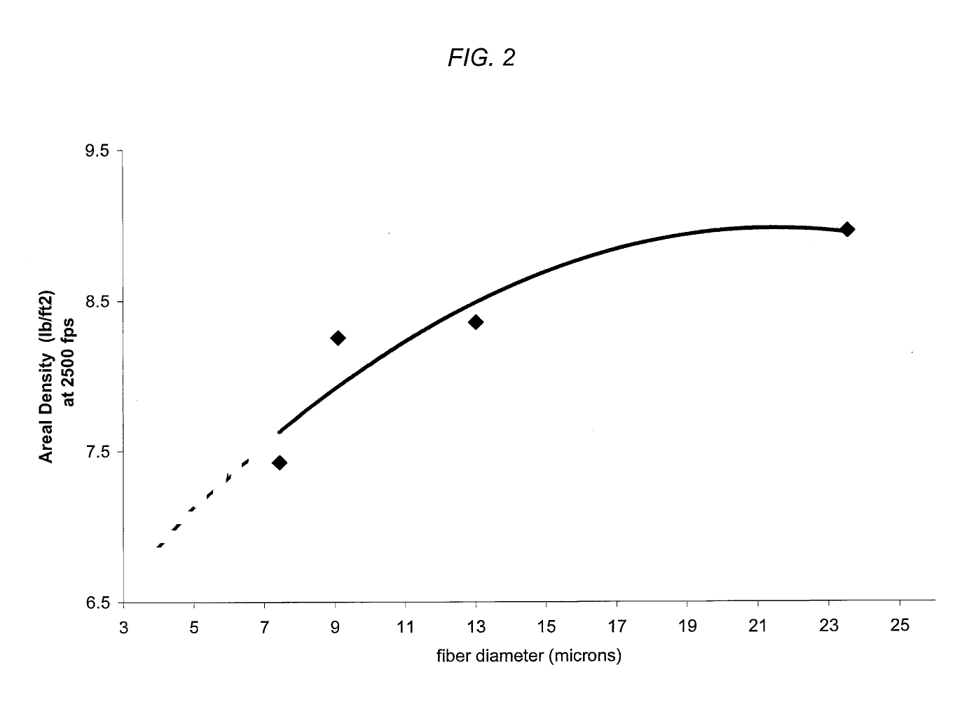

FIG. 2 shows the calculated areal density as a function of fiber diameter required to achieve a V50 of 2500 fps. Extrapolation (dotted line) of the data of FIG. 2, which includes the ballistic impact resistant panels comprising 24, 13, 9, and 7 micron S-glass fibers, suggests further improvements in ballistic impact resistance articles with less areal density can be obtained with even smaller fiber diameters.

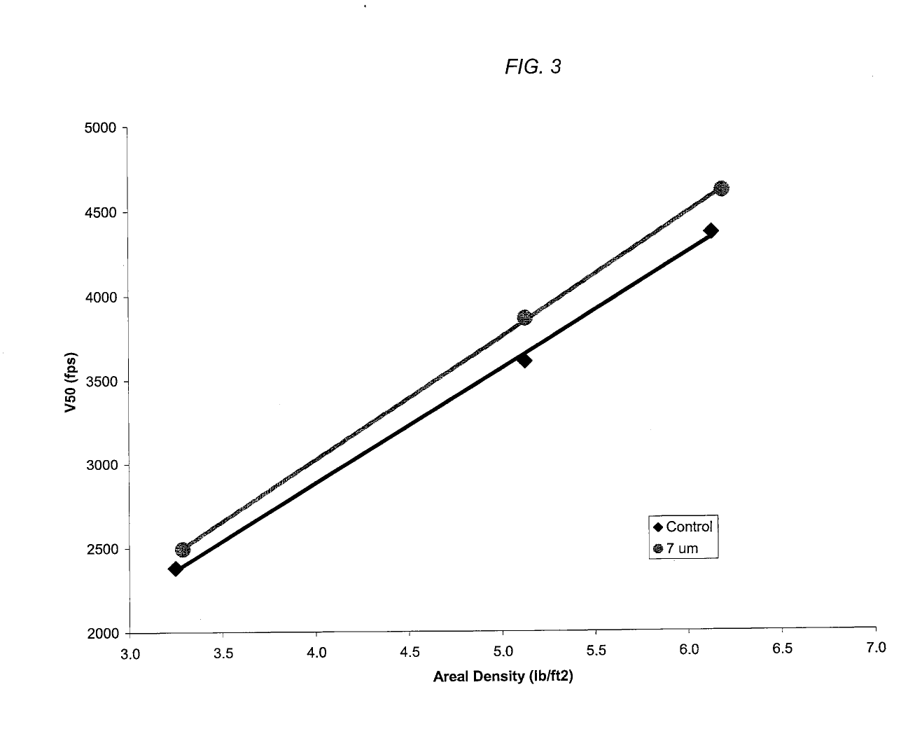

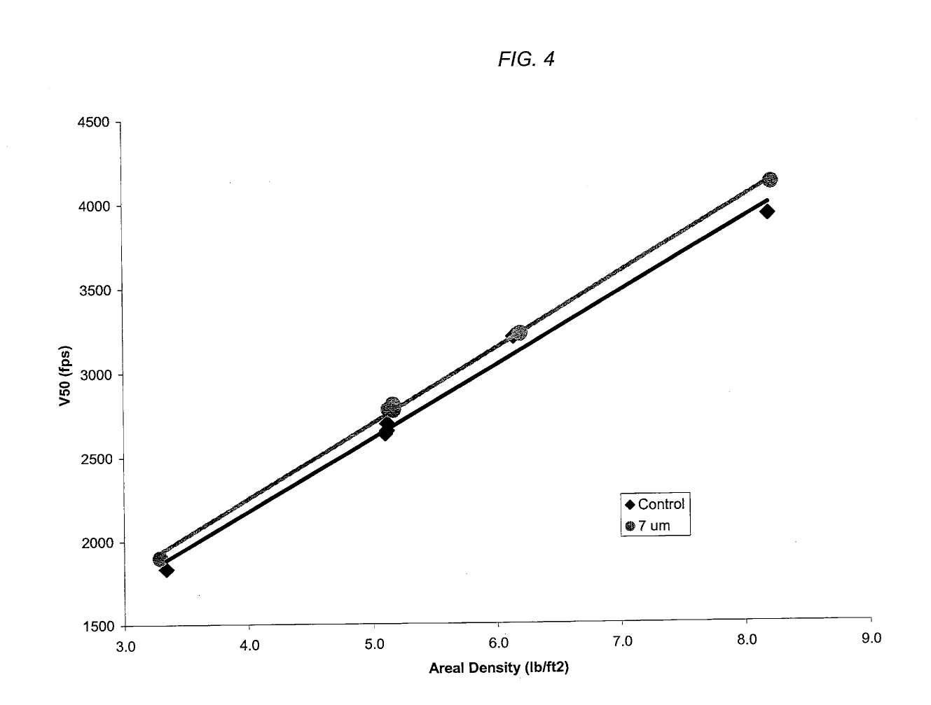

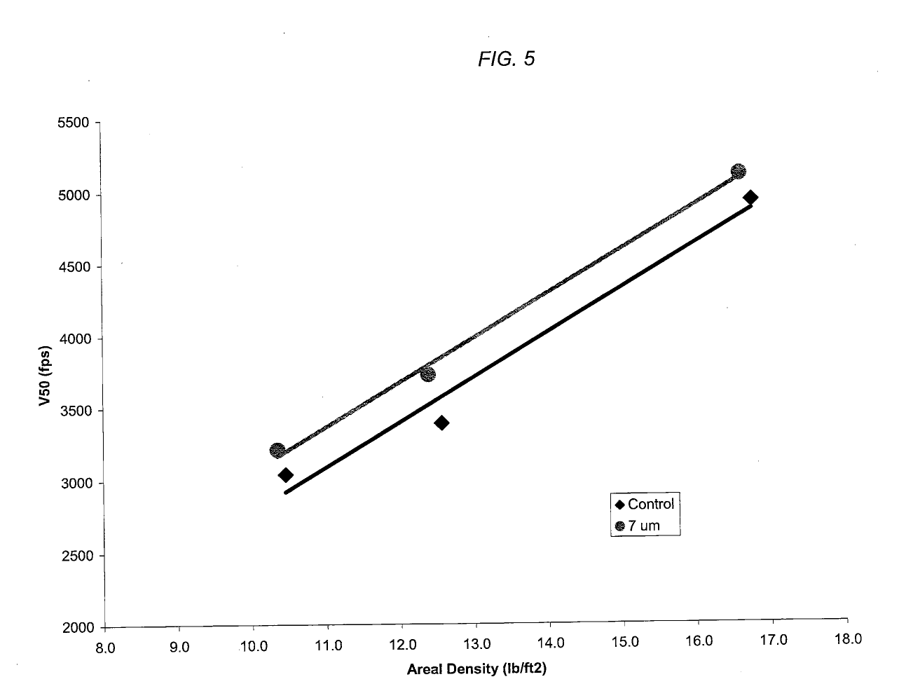

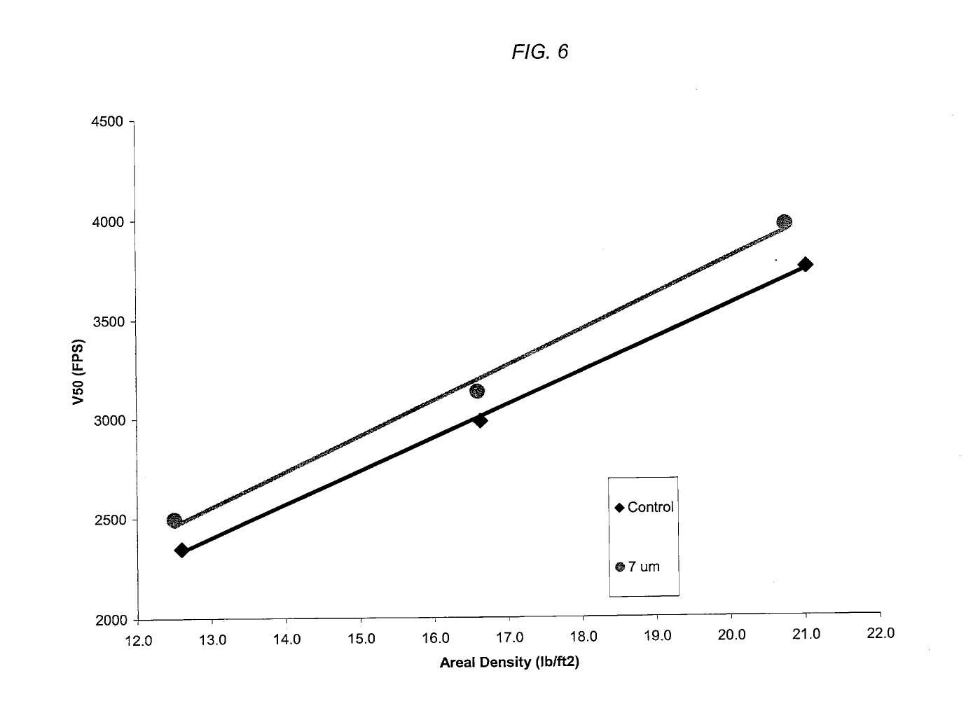

In a similar manner, V50 performance curves for various sizes of fragment simulated projectiles (FSP) were measured on unfaced ballistic resistant composite panels as described in Table 1. Thus, FIGS. 3-6 graphically depict V50 performance curves for FSP's of 5.56 mm, 7.62 mm, 12.7 mm and 20 mm. Each of the data sets of FIGS. 3-6 demonstrates that reduction of fiber diameter in composite panels results in improved ballistic resistant properties compared to composite panels of the same matrix and equivalent areal density with greater than 9 micron fibers. Therefore, it is now possible using the ballistic resistant composite panels as described herein to reduce the areal density (and therefore the weight) of a composite panel for a given targeted V50 value.

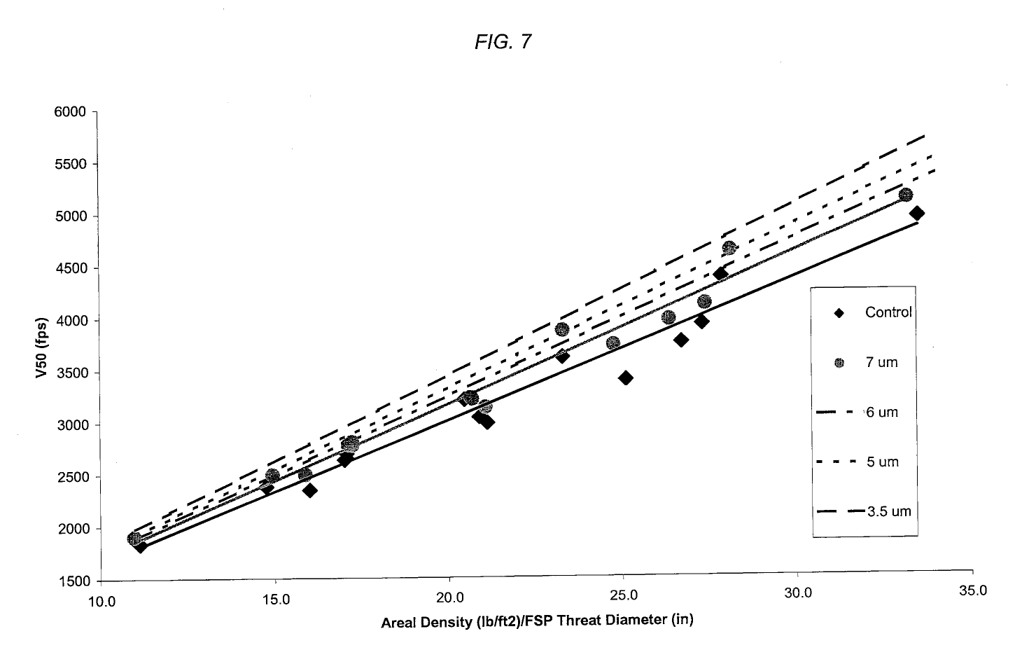

FIG. 7 graphically depicts normalized FSP threat (areal density/FSP diameter) versus average V50 values for control and 7 micron containing panels as described herein. The data of FIG. 7 demonstrates that reduction of fiber diameter in composite panels results in improved ballistic resistant properties compared to composite panels of the same matrix with greater than 9 micron fibers. In addition, FIG. 7 includes prophetic linear regression curves of hypothetical panels of thermoset resin and finer diameter fibers of 6 micron, 5 micron and 3.5 micron as dotted curves calculated based on estimated areal densities, respectively.

The improved ballistic performance observed for the finer fiber 7 micron and below is unexpected based on predictive models that relate projectile velocity to areal density. For example, models constructed from the data relating bullet velocity to areal density for the ballistic composite panels was as follows:
For the 7 micron finer diameter fiber:

Y=34.169X+1256.8 R²=0.9998;
For the control model:

Y=36.695X+1015.9 R²=0.9879;
where
Y is the 7.62 mm M80 V50 velocity in feet per second;
X is the areal density of the ballistic composite panel in kg/m².

For example, if an assumption were made that a 7.62 mm M80 threat is 2500 fps, then according to the control model equation, a ballistic resistant composite panel with an areal density of 40.44 kg/m² would be required to provide the requisite V50 value. Unexpectedly, the data obtained from the 7 micron ballistic resistant composite panel with an areal density of 36.38 kg/m² provides comparable ballistic resistance with about 11% less weight. Therefore, the foregoing also demonstrate that the ballistic impact resistant article or composite from finer fiber as described herein yields a higher average V50 value at the same areal density, or the same average V50 value at a lower areal density.

While the invention has been described in detail and with reference to specific aspects thereof, it will be apparent to one skilled in the art that various changes and modifications may be made without departing from the spirit and scope of the invention.

We claim:

1. A ballistic impact resistant article comprising a glass fiber of less than 9 micron filament diameter and a resin;
wherein the glass fiber consists essentially of:

| | |
|---|---|
| SiO₂ | 56-66% |
| Al₂O₃ | 10-26% |
| MgO | 5-15% |
| CaO | 0-10% |
| B₂O₃ | 0-1% |
| alkali metal oxides | 0-1% |
| Fe₂O₃ | 0-0.5% |
| F₂ | 0-0.5%. |

2. The ballistic impact resistant article of claim 1, wherein the glass fiber has a pristine fiber tensile strength of greater than 500 kpsi.

3. The ballistic impact resistant article of claim 1, wherein the glass fiber diameter is about 7 microns to less than 9 microns.

4. The ballistic impact resistant article of claim 1, wherein the glass fiber diameter is about 3.5 microns to about 7 microns.

5. The ballistic impact resistant article of claim 1, wherein the glass fiber is S-glass or R-glass.

6. The ballistic impact resistant article of claim 1, further comprising a hard strike face.

7. The ballistic impact resistant article of claim 6, wherein the hard strike face is ceramic.

8. The ballistic impact resistant article of claim 1, wherein the resin is selected from the group consisting of thermosetting resins, thermoplastic resins, and elastomeric resins.

9. The ballistic impact resistant article of claim 1, wherein the resin is a thermosetting resin.

10. The ballistic impact resistant article of claim 1, wherein the thermosetting resin is a phenolic resin.

11. The ballistic impact resistant article of claim 1, wherein the ballistic impact resistant article has a glass fiber weight fraction of about 80%.

12. The ballistic impact resistant composite of claim 1, wherein the glass fiber has a water resistant, impact debondable size coating thereon.

13. The ballistic impact resistant composite of claim 12, wherein the water resistant, impact debondable size coating comprises an epoxy based film former and a silane coupling agent.

14. The ballistic impact resistant composite of claim 1, wherein the article comprises one or more layers, wherein at least one of the layers is a woven or a non-woven network of the glass fiber.

15. The ballistic impact resistant composite of claim 14, wherein the network of glass fiber is non-woven chopped fibers.

16. The ballistic impact resistant composite of claim 14, wherein the woven network of glass fiber is selected from the group consisting of a plain weave, a twill weave, three-dimensional weave, a harness weave, a basket weave and a satin weave.

17. The ballistic impact resistant composite of claim 14, wherein the network of glass fiber comprises a sheet-like filament array in which the filaments are arranged substantially parallel to one another along a common filament direction.

18. The ballistic impact resistant composite of claim 14, wherein the composite comprises at least two layers, wherein each of the at least two layers comprises a sheet-like filament array, wherein each layer has the filaments arranged substantially parallel to one another along a common filament direction, and wherein the at least two layers are aligned at substantially 90 degree angles with their respective parallel glass filaments.

19. A ballistic impact resistant article comprising a glass fiber having a diameter of less than 9 microns, wherein the glass fiber has the following characteristics:
a pristine fiber tensile strength at room temperature of greater than 500 kpsi;
a composition comprising about 64-66% by weight silica, about 24-26% by weight alumina, and about 9-11% by weight magnesia; and
at least one of the following:
i) a softening point of greater than 1900° F. as determined in accordance with ASTM C-338;
ii) a tensile modulus at room temperature of greater than 12.5 Mpsi as determined in accordance with ASTM D2101;
iii) a strain to failure of greater than 5.4% as determined in accordance with ASTM D2101; and
iv) a dimensional stability of less than 2.0×10⁻⁶ in/in-degrees ° F.

20. The ballistic impact resistant article of claim 19, further comprising a hard strike face.

21. The ballistic impact resistant article of claim 20, wherein the hard strike face is ceramic.

22. A process for constructing a ballistic impact resistant article, the process comprising
(i) providing at least one layer of a woven or fiber network, the woven or fiber network comprising a glass fiber of less than about 9 micron filament diameter;
(ii) impregnating the at least one layer of woven or fiber network with a resin;
(iii) stacking the at least one layer of woven or fiber network impregnated with resin; and
(iv) consolidating the stack of at least one layer of woven or fiber network impregnated with resin under compression;
wherein the glass fiber has a pristine fiber tensile strength of greater than 500 kpsi;
wherein a ballistic impact resistant article is constructed.

23. A method of reducing a fragment projectile penetration threat comprising:
providing a ballistic impact resistant article comprising glass fibers having a diameter of less than 9 microns and a resin;
wherein the ballistic impact resistant article has a characteristic selected from the group consisting of:
an areal density of about 6.2 pounds per square foot at a thickness of about 0.58 inches and an average V50 value, protection ballistic limit in excess of about 4400 feet per second with 5.56 mm fragment simulating projectiles;
an areal density of about 5.2 pounds per square foot at a thickness of about 0.48 inches and an average V50 value, protection ballistic limit in excess of 2700 feet per second with 7.62 mm fragment simulating projectiles;
an areal density of about 12.4 pounds per square foot at a thickness of about 1.2 inches and an average V50 value, protection ballistic limit in excess of 3450 feet per second with 12.7 mm fragment simulating projectiles; and
an areal density of about 20.8 pounds per square foot at a thickness of about 2 inches and an average V50 value, protection ballistic limit in excess of 3800 feet per second with 20 mm fragment simulating projectiles.

24. The method of claim 23, wherein the ballistic impact resistant article further comprises a hard strike face.

25. The method of claim 23, wherein the hard strike face is ceramic.

26. The method of claim 23, wherein the glass fiber has the following characteristics:
a pristine fiber tensile strength at room temperature of greater than 500 kpsi;
a composition consisting essentially of about 64-66% by weight silica, about 24-26% by weight alumina, and about 9-11% by weight magnesia; and
at least one of the following:
i) a softening point of greater than 1900° F. as determined in accordance with ASTM C-338;
ii) a tensile modulus at room temperature of greater than 12.5 Mpsi as determined in accordance with ASTM D2101;
iii) a strain to failure of greater than 5.4% as determined in accordance with ASTM D2101; and
iv) a dimensional stability of less than 2.0×10⁻⁶ in/in-degrees ° F.
